(19) United States
(12) Patent Application Publication
(10) Pub. No.: US 2004/0001216 A1
(43) Pub. Date: Jan. 1, 2004

(54) Method for preventing repeat printing to a document

(76) Inventors: Sheng-Chih Lin, Taipei City (TW); Kuan-Chih Huang, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,971

(22) Filed: Sep. 5, 2002

(30) Foreign Application Priority Data
Jun. 27, 2002 (TW) 091114224

(51) Int. Cl. G06F 3/12; G06F 15/00; G06F 11/30

(52) U.S. Cl. 358/1.14; 358/3.28; 382/317

(57) ABSTRACT

A method that prevents a printer from repeatedly printing to a document is disclosed. The printer includes a sensor, and the printer is capable of receiving the document and printing data onto the document. When the printer prints to the document, the printer can also print a printing sign onto the document. The method includes, after the printer has received the document, using the sensor to detect whether the document has the printing sign. If the document does not have the printing sign, the printer starts to print data onto the document. If the document has the printing sign, the printer ejects the document without printing to it.

### BACKGROUND OF INVENTION

1.Field of the Invention

The present invention relates to a method for printing a document, and more particularly, to a method for preventing a printer from repeat printing the document.

2.Description of the Prior Art

Please refer to FIG. 1. FIG. 1 is a cross-sectional view of a prior art thermal transfer printer 10. The thermal transfer printer 10 comprises a first capstan roller 12 and a first pinch roller 14 that is located above the first capstan roller 12 to press a piece of paper 16 onto the first capstan roller 12. The first capstan roller 12 is driven by a motor (not shown) that is inside the thermal transfer printer 10. The first capstan roller 12 can rotate clockwise and counterclockwise to drive the paper 16 forward and backward with the first pinch roller 14. The thermal transfer printer 10 further comprises a thermal print head 18 and a platen roller 20 that is under the thermal print head 18 and presses the paper 16 against the thermal print head 18 during printing. The thermal print head 18 comprises an ink ribbon (not shown) and heats ink in the ink ribbon to print onto the paper 16. Operation of the thermal transfer printer 10 is as follows.

Please refer to FIG. 2. FIG. 2 is a cross-sectional view of the thermal transfer printer 10 showing a front section 16a of the paper 16 being driven under the thermal print head 18. When the printer 10 receives a command to print, the motor inside the printer 10 starts to drive the first capstan roller 12. The first capstan roller 12 and the first pinch roller 14 operating in coordination, drive the paper 16 into the printer 10, as is also shown in FIG. 1 (in FIG. 1, a dashed line indicates the forward path of the paper 16.). In addition, the printer 10 further comprises a second capstan roller 22 and a second pinch roller 24 that operate in the same way as the first capstan roller 12 and the first pinch roller 14. When the paper 16 enters the printer 10, it is driven by the second pinch roller 22 until the front section 16a of the paper 16 arrives at the thermal print head 18, as shown in FIG. 2.

The thermal print head 18 starts to print data onto the paper 16 from the front section 16a of the paper 16 to a back section 16b of the paper 16. While printing, the paper 16 moves in a direction indicated by a dashed line shown in FIG. 2. The paper 16 is driven by the second capstan roller 22 until the paper 16 reaches the first capstan roller 12 and first pinch roller 14. The paper 16 is then driven by the first capstan roller 12 until printing is finished and the back section 16b of the paper 16 is again between the first capstan roller 12 and the first pinch roller 14, as shown in FIG. 1. The ink ribbon of the thermal transfer printer 10 has several colors and the thermal print head 18 prints one color onto the paper 16 at a time. In other words, in the preceding printing process, the thermal print head 18 only prints one color. If the thermal print head 18 needs to print two colors onto the paper 16, the printer 10 has to repeat the preceding process to print a second color. After finishing printing all colors, the printer 10 ejects the paper 16.

Generally speaking, the paper 16 used by the thermal transfer printer 10 is specially produced for the thermal transfer printer 10. The paper 16 can be used only once, and cannot be repeatedly used in separate printing processes. Typically, the paper 16 after printing has at least one layer of ink on it. Heat from the thermal print head 18 causes previously printed ink to melt and results in the paper 16 adhering to the ink ribbon. This will stop printing and can even destroy the ink ribbon.

### SUMMARY OF INVENTION

It is therefore a primary objective of the claimed invention to provide a method for preventing a printer from repeat printing documents to solve the above-mentioned problem.

According to the claimed invention, a method for preventing a printer from repeat printing a document is provided. The printer includes a sensor, and the printer is capable of receiving the document and printing data onto the document. When the printer prints the document, the printer can also print a printing sign onto the document. The method includes, after the printer has received a document, using the sensor to determine whether the document has the printing sign. If the document does not have the printing sign, the printer prints data onto the document. If the document has the printing sign, the printer does not print data onto the document.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a cross-sectional view of a thermal transfer printer according to the prior art.

FIG. 2 is a cross-sectional view showing operation of the thermal transfer printer of FIG. 1.

FIG. 3 is a cross-sectional view of a thermal transfer printer according to the present invention.

FIG. 4 is a plan view of a piece of paper that is unprinted.

FIG. 5 is a plan view of a piece of paper that is printed.

FIG. 6 is a flowchart of a method for printing according to the present invention.

### DETAILED DESCRIPTION

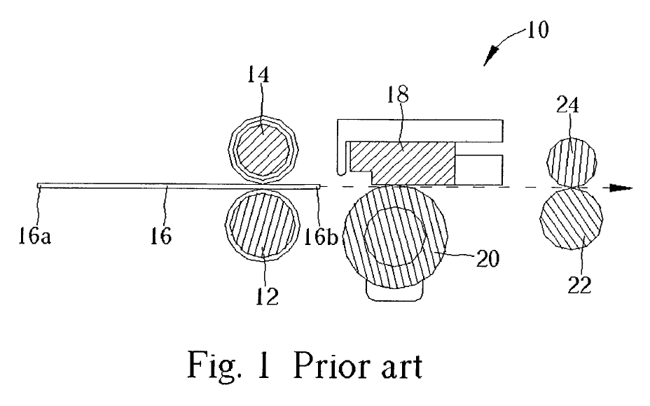

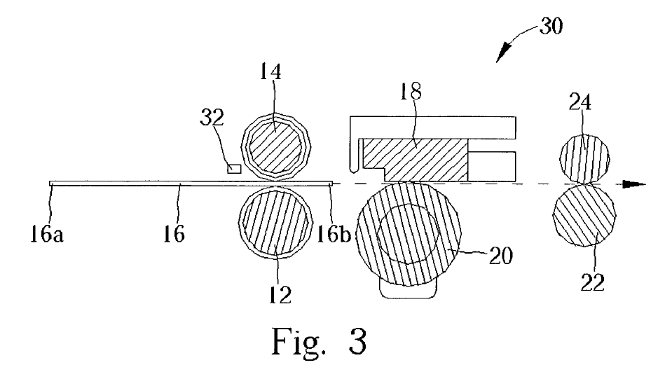

Please refer to FIG. 3. FIG. 3 is a cross-sectional view of a thermal transfer printer 30 according to the present invention. For simplicity of description of the present invention, reference numerals in FIG. 3 are the same as those in FIG. 1 and like indicated parts have the same function and operation. The difference between the thermal transfer printer 30 according to present invention and the printer 10 according to the prior art is that the present invention printer 30 comprises a sensor 32. The sensor 32 is used to detect a sign on the paper 16. Operation of the thermal transfer printer 30 is as follows.

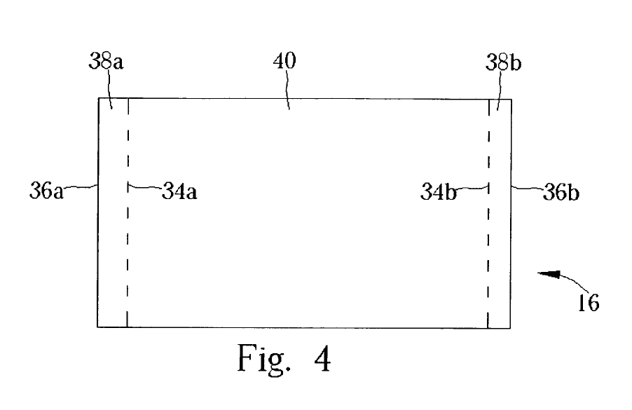

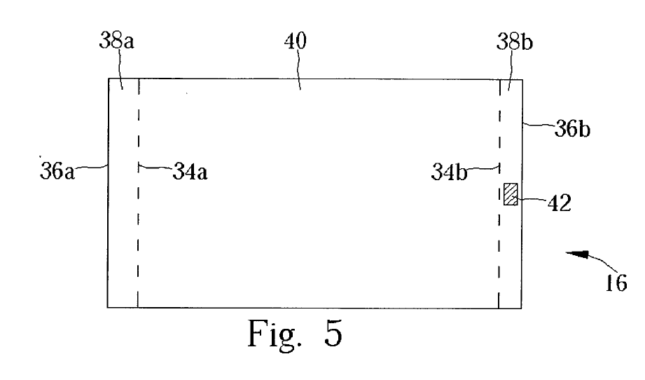

Please refer to FIG. 4 and FIG. 5. FIG. 4 is a plan view of the unprinted piece of paper 16. FIG. 5 is a plan view of the paper 16 after being printed to. The paper 16 comprises a printing area 40 that is between a front dashed line 34a and a back dashed line 34b, which is namely the printing area of the thermal print head 18. An area between the front dashed line 34a and a front edge 36a of the paper 16 is a front area 38a. An area between the back dashed line 34b and a back edge 36b of the paper 16 is a back area 38b. The front area 38a and the back area 38b enable the rollers inside the printer 30 to grip the paper 16 and will not have data printed onto them. The method of the present invention is to print a printing sign 42 at a specific location of the back area 38b, when the thermal print head 18 prints each color onto the paper 16.

When the paper 16 is fed into the printer 30, the printer 30 according to present invention uses the sensor 32 to detect whether the front area 38a and the back area 38b of the paper 16 have the printing sign 42 to determine if the paper 16 is printed or unprinted. If the sensor does not detect the printing sign 42 in the front area 38a or the back area 38b of the paper 16 the paper 16 is clean, that is unprinted. Therefore, the printer 30 prints data onto the paper 16 and further prints the printing sign 42 at the specific location of the back area 38b for any number of colors that are printed to the paper 16. Finally, the paper 16 is ejected from the printer 30 when printing is finished. It should be mentioned that the sensor 32 only detects the paper 16 when it enters the printer 30. When the paper 16 is detected as clean, the sensor 32 will do nothing more until the paper 16 finishes printing and a next piece of paper enters the printer 30. In other words, the sensor 32 only detects for the printing sign 42 on the paper 16 before the thermal print head 18 prints a first color, but does nothing when it prints a second color or further colors. When the printer 30 feeds the paper 16 along a dashed line as shown in FIG. 3, if the sensor 32 detects the printing sign 42 on the front area 38a of the paper 16 the paper 16 is printed but inserted into the printer 30 in reverse. Similarly, the printer 30 will immediately eject the paper 16 and not print data onto it. In this way, the printer 30 prevents the paper 16 from being repeatedly printed to.

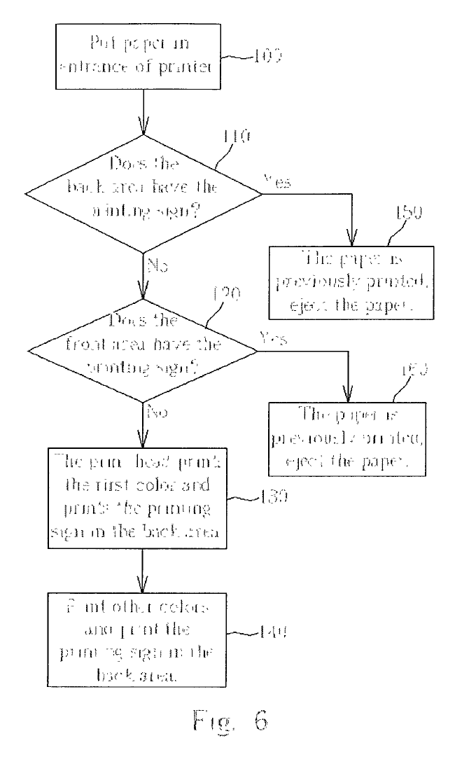

Please refer to FIG. 6. FIG. 6 is a flowchart of a method for printing according to the present invention. The steps are as follows:

Step 100:

Put the paper 16 in a paper entrance of the printer 30 and feed it between the first capstan roller 12 and the first pinch roller 14;

Step 110:

The first capstan roller 12 drives the paper 16 forward, simultaneously the sensor 32 inside the printer 30 starts to detect the paper 16. Because the back area 38b of the paper 16 enters the printer 30 first, the sensor 32 will first detect the back area 38b of the paper 16 to sense whether the printing sign 42 is present. If the back area 38b does not have the printing sign 42, execute step 120. If the back area 38b has the printing sign 42, execute step 150;

Step 120:

The first capstan roller 12 drives the paper 16 forward. When the paper 16 passes below of the sensor 32, the sensor 32 will detect if the front area 38a has the printing sign 42. If the front area 38a does not have the printing sign 42, execute step 130. Otherwise, execute step 160;

Step 130:

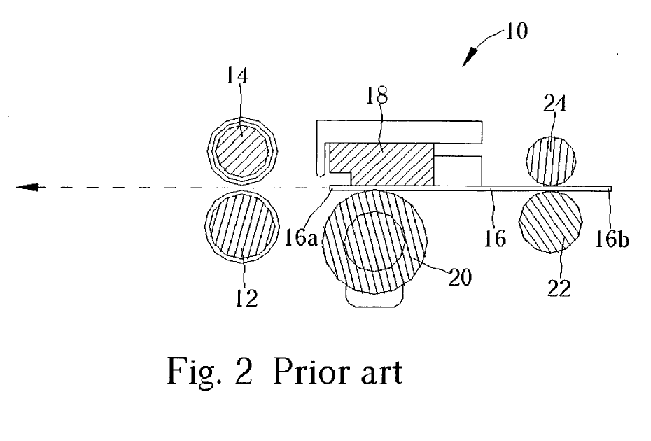

Because the front area 38a and the back area 38b both do not have the printing sign 42, the paper 16 is detected as clean. At the same time, the paper 16 is driven forward by the second capstan roller 22 until the front of the paper 16 is under the thermal print head 18 as shown in FIG. 2. The thermal print head 18 starts to print, the paper 16 is driven, and the thermal print head 18 prints data from the front dashed line 34a to the back dashed line 34b. After finishing one color, the thermal print head 18 will print the printing sign 42 on the back area 38b of the paper 16;

Step 140:

Generally speaking, the thermal print head 18 has to print over two colors onto the paper 16, so the printer 30 has to repeat the step 130, namely using the first capstan roller 12 and the second capstan roller 22 again to drive the paper 16 into the printer 30 such that the thermal print head 18 can print additional colors onto the paper 16. (The thermal print head 18 always prints data from the front dashed line 34a to the back dashed line 34b). Similarly, after printing the second color, the thermal print head 18 will print the printing sign 42 at the same location of the back area 38b of the paper 16. This process is repeated until the thermal print head 18 prints all colors. Finally, the paper 16 is ejected from the printer 30. If a user puts the paper 16 into the printer 30 again the sensor 32 will detect the printing sign 42 and the printer 30 will not print data onto the paper 16, but instead will eject the paper 16 to prevent to the paper 16 from adhering to the ink ribbon resulting in failure of the ink ribbon;

Step 150:

Because the back area 38b of the paper 16 has the printing sign 42. The paper 16 is determined to have been previously printed to. The first capstan roller 12 rotates in reverse to drive the paper 16 to eject from the printer 30 without the printer 30 printing anything;

Step 160:

The front area 38a of the paper 16 has the printing sign 42. The paper 16 is determined to have been previously printed and set into the printer 30 in reverse. In this step, the first capstan roller 12 rotates in reverse to drive the paper 16 to eject from the printer 30 without the printer 30 printing anything.

According to the above-mentioned procedure, the present invention can effectively prevent the printer 30 from printing data onto the paper 16 if the paper 16 has already been printed to and thus can prevent damage to the ink ribbon. In the above-mentioned procedure, the printer 30 prints the printing sign 42 onto the back area 38b of the paper 16, however, according to the present invention, the printer 30 can print the printing sign 42 onto the front area 38a, the back area 38b, or both areas 38a, 38b. In addition, the printing sign 42 can also be any sign or symbol inside the print area 40. The sensor 32 can detect the printing sign 42, so naturally it can detect a sign or symbol in the print area 40. The method according to the present invention can also detect a sign or symbol in the print area 40 to determine whether a document is printed. In addition to the thermal transfer printer 30 that is mentioned above, the method of present invention also applies to a thermal inkjet printer, a dot matrix printer, an inkjet printer, and an electrostatic printer.

In contrast to the prior art, the present invention method prints a printing sign outside or inside of a print area of a piece of paper to indicate that the paper has already had data printed to it. After putting the paper into a printer, the printer detects for the printing sign on the paper to determine whether the paper is clean or whether the paper already contains printed data. Therefore, the present invention is an effective method of preventing the printer from repeatedly printing onto the paper and protects the paper and an ink ribbon from damage.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for preventing repeat printing to a document by a printer, the printer comprising a sensor, the printer capable of receiving the document and printing data onto the document, the method comprising:
receiving the document;
determining if the document has a printing sign using the sensor;
printing data onto the document with the printer when the document does not have the printing sign; and
printing the printing sign onto the document with the printer when the document does not have the printing sign.

2. The method of claim 1 wherein the printer prints data onto the document inside a print area of the document, and the printer prints the printing sign onto the document outside the print area of the document.

3. The method of claim 1 wherein the printing sign is a sign inside a print area of the document.

4. The method of claim 1 wherein the printer further comprises an ink ribbon and a print head, and the print head heats ink in the ink ribbon to print onto the document.

5. The method of claim 4 wherein the printer further comprises a platen roller that presses the document against the print head.

6. The method of claim 4 wherein the print head is a thermal print head.

7. The method of claim 1 wherein the printer prints one color at a time.

8. The method of claim 1 wherein the printer further comprises a capstan roller and a pinch roller capable of driving the document forward and backward.

9. The method of claim 8 wherein the printer further comprises a motor that drives the capstan roller to rotate.

10. The method of claim 1 wherein the printer is a thermal transfer printer.

11. The method of claim 1 wherein the printer is a thermal inkjet printer.

12. The method of claim 1 wherein the printer is a dot matrix printer.

13. The method of claim 1 wherein the printer is an inkjet printer.

14. The method of claim 1 wherein the printer is an electrostatic printer.
